(19) United States
(12) Patent Application Publication
(10) Pub. No.: US 2004/0139354 A1
(43) Pub. Date: Jul. 15, 2004

(54) System for user authentication

(75) Inventors: Kenneth Roger Jones, Cool, CA (US); Brian Gonsalves, Pleasanton, CA (US); Zesen Chen, Pleasanton, CA (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: SBC Properties, L.P., Reno, NV

(21) Appl. No.: 10/339,139

(22) Filed: Jan. 9, 2003

(51) Int. Cl. H04L 9/32

(52) U.S. Cl. 713/202

(57) ABSTRACT

A system for user authentication includes a computing device, a customer premise equipment, and an authentication device. The authentication device is remotely located from the computing device and includes one or more processing resources. Embedded within the processing resource is Point-to-Point Protocol over Ethernet (“PPPoE”). The authentication device is operable to utilize the PPPoE to authenticate one or more users of the computing device and the customer premise equipment. The authentication device further includes a housing to enclose the processing resource, one or more Ethernet input/output ports in order to communicate with the computing device and the customer premise equipment, and an indicator to indicate to the user an operating status for the authentication device. Once the authentication device authenticates the user, the authentication device becomes transparent to the computing device with no routing or bridging functionality.

### BACKGROUND OF THE INVENTION

In order for users to access the Internet, the identity of the user must be authenticated by the network and the user's service provider. With respect to DSL (“Digital Subscriber Line”) connections, service providers typically use Point-to-Point Protocol over Ethernet (“PPPoE”) to authenticate each user and therefore allow for a secure DSL connection with the users' computers. To utilize PPPoE, software including PPPoE is installed on the users' computers. The software creates a virtual network interface card (“NIC”) within the user's computer and allows for the user to be authenticated. But the installation of the PPPoE software typically creates problems with the users' computers. The PPPoE software is not compatible with virtual private networks (“VPN”) which are utilized by a number of service providers. In addition, other application software and operating systems installed on the users' computers have difficulty interacting with the PPPoE software. The incompatibility of the PPPoE software with such software generates problems in the users' computers and the DSL connection resulting in numerous trouble reports and customer care requests requiring service calls by the service providers which are frustrating for the user and expensive and time consuming for the service providers.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a schematic diagram of an example embodiment of a system for authenticating one or more DSL users; and

FIG. 2 depicts a block diagram of an example authentication device.

### DETAILED DESCRIPTION OF THE INVENTION

Preferred embodiments of the present invention are illustrated in the figures, like numerals being used to refer to like and corresponding parts of the various drawings.

Numerous Internet service providers are now providing broadband Internet services such as DSL to residential customers and business customers. Before the DSL users can access the Internet, the DSL users' identity must be authenticated by the network and the service provider. In order to authenticate the users, the service providers currently utilize Point-to-Point Protocol over Ethernet (“PPPoE”) operating under the IETF RFC 2516 standard (“Internet Engineering Task Force Request for Comment”). PPPoE is a specification for connecting multiple computer users on an Ethernet LAN (“local area network”) to a remote site through customer premise equipment generally located at the users' site. PPPoE combines the Point-to-Point Protocol (“PPP”) used in dialup connections with the Ethernet protocol where the PPP information is encapsulated within an Ethernet frame. PPPoE allows for a house, office, or building to share a common DSL connection to the Internet.

DSL connections allow for multiple users to share the same physical connection to the service provider. Therefore, user traffic needs to be monitored and tracked for billing purposes and to control traffic flow. PPPoE provides for each user site to learn the network addresses of the other user sites on the DSL connection during an initial exchange. When the DSL connection has been established between the user and the service provider, the DSL session can be monitored for billing and traffic flow purposes thereby allowing for shared Internet access over DSL connections.

In order to utilize PPPoE to authenticate DSL users, service providers generally install software including PPPoE on the users' computers which allows for secure DSL connections. The PPPoE software creates a virtual NIC within the users' computers. But the virtual NIC is not compatible with application software already installed on the users' computers and the software has trouble interacting with other software including VPNs and operating systems such as MICROSOFT WINDOWS. For example, the incapability can result in business DSL users not being able to create a VPN tunnel from the home user to the corporate office. The errors created in the users' computers by the virtual NIC and the associated PPPoE software frustrate the users and result in the users becoming dissatisfied with the service provider.

Furthermore, the incapability of the PPPoE software installed on the users' computers is also an inconvenience to the service provider due to the cost and time spent by the service provider responding to the numerous service calls placed by frustrated customers experiencing problems with their computers created by the PPPoE software. When a customer calls the service provider with an error with their DSL connection, a customer service representative (“CSR”) attempts to solve the problem over the telephone. If the problem cannot be resolved over the telephone, the service provider must send a technician to the user's site to diagnose and correct the error. But even after a technician visit corrects the error, the error may occur again due to the ongoing incapability problems of the PPPoE software installed on the users' computers. Both the CSR's time on the telephone and technician's visit to the user site are expensive and time consuming and cost the service provider money and employee time which would be better spent on revenue generating projects.

By contrast, the example embodiment described herein allows for the authentication of users utilizing PPPoE without installing PPPoE on the users' computers. Additionally, the example embodiment allows for a low cost authentication device remote from the user's computer to authenticate DSL users. Since PPPoE is not installed on the users' computers, the users no longer experience the incapability problems described above and therefore are more satisfied with their DSL connections because less errors occur. In addition, time and money are saved because service provider employees are no longer spending time diagnosing and solving problems created by the installed PPPoE software's incapability with other software installed on the users' computers. Therefore, the users remain satisfied with their DSL service and service provider and the service provider employees' time may be better utilized in other revenue generating projects.

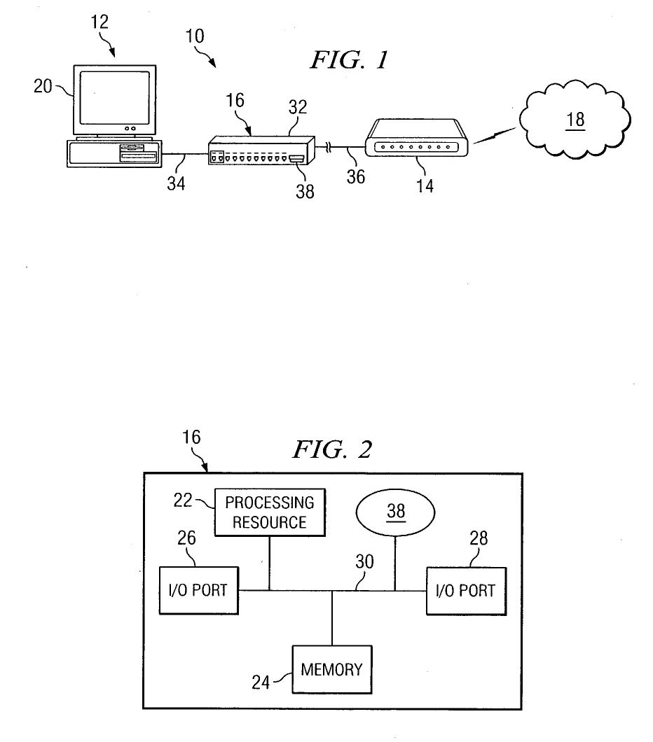

Referring now to FIG. 1, a schematic diagram of an example embodiment of a system for authenticating one or more DSL users is depicted. Authentication system 10 includes computing device 12, customer premise equipment 14, and authentication device 16 with customer premise equipment 14 in communication with computing device 12 and network 18. Customer premise equipment (“CPE”), also known as subscriber equipment, includes any equipment that is connected to a telecommunications network and located at a customer or user's site. CPE 14 may be a telephone, a 56 k modem, a cable modem, a DSL modem, a phone set, fax equipment, an answering machine, a set-top box, POS (point-of-sale) equipment, a PBX (private branch exchange) system, a personal computer, a laptop computer, a personal digital assistant (PDA), or any other appropriate type or combination of communication equipment installed at the user's site. CPE 14 may be equipped for connectivity to wireless or wireline networks, for example via a public switched telephone network (PSTN), digital subscriber lines (DSLS), cable television (CATV) lines, or any other appropriate communications network. In the example embodiment of FIG. 1, CPE 14 is shown as a DSL modem but in alternate embodiments may be any other appropriate type of customer premise equipment.

Computing device 12, CPE 14, and authentication device 16 are located at the user's premise. The user's premise may include a home, business, office, or any other appropriate location where a user may desire to access a network such as the Internet. Computing device 12 may be a personal computer, a laptop computer, a server, a PDA, or any other appropriate computing device and may further include monitor 20 for displaying a user interface. Computing device 12 accesses network 18 through CPE 14 where network 18 may be a public switched telephone network, the Internet, a wireless network, or any other appropriate type of communication network.

Referring now to FIG. 2, a block diagram depicts authentication device 16 in greater detail. In the example embodiment, authentication device 16 may include respective software components and hardware components, such as processing resource 22, memory 24, and input/output (“I/O”) ports 26 and 28. These components are disposed within housing 32 and may work together via bus 30 to provide the desired functionality of user authentication. Processing resource 22 may be a microprocessor, a microcontroller, a digital signal processor (“DSP”), or any other digital circuitry configured to execute an operating system, instructions, or any services provided by computing device 12, CPE 14, or memory 24.

Authentication device 16 is provided to the user by the service provider and is located at the user's site but is located remotely from computing device 12. The service provider may provide authentication device 16 at the same time the service provider provides CPE 14 to the user or at a later date after the user has already been provided CPE 14. In the embodiment shown in FIG. 1, authentication device 16 is located between computing device 12 and CPE 14. In alternate embodiments, authentication device 16 may be located within CPE 14.

Computing device 12 communicates with authentication device 16 via Ethernet cable 34. Ethernet cable 34 includes an RJ-45 connector at each end of cable 34 where one RJ-45 connector plugs into a port on a NIC or Ethernet card within computer device 12 and the other RJ-45 connector plugs into I/O port 26 of authentication device 16. Authentication device 16 communicates with CPE 14 via Ethernet cable 36 also including an RJ-45 connector at each of cable 36. One end of Ethernet cable 36 plugs into I/O port 28 of authentication device 16 while the other RJ-45 connector of Ethernet cable 36 plugs into an Ethernet port on CPE 14. Communications originating from computing device 12 travel along Ethernet cable 34, through authentication device 16, along Ethernet cable 36 to CPE 14 and network 18. Communications from network 18 and CPE 14 travel along Ethernet cable 36, through authentication device 16, and along Ethernet cable 34 to computing device 12. In alternate embodiments, authentication device 16 may communicate with computing device 12 and CPE 14 via wireless communication and therefore not require Ethernet cables 34 and 36.

Because authentication device 16 utilizes standard Ethernet connections, installation of authentication device 16 requires no change in the connectors on computing device 12 and CPE 14. Furthermore, Ethernet cables 34 and 36 may be integrated into authentication device 16 so that the user only has to connect Ethernet cable 34 to computing device 12 and Ethernet cable 36 to CPE 14. Because installation of authentication device 16 requires plugging Ethernet cable 34 into computing device 12 and authentication device 16 and plugging Ethernet cable 36 into CPE 14 and authentication device 16, installation of authentication device 16 can be accomplished by a user possessing minimal computer knowledge.

Authentication device 16 is designed to be an inexpensive component that is small in size and manufactured with off-the-shelf components allowing for the low cost. The low cost and design of authentication device 16 allows for authentication device 16 to be a “throw-away” device. Therefore, when authentication device 16 no longer functions correctly, authentication device 16 is thrown away and replaced instead of repaired. Because of the design, it is cheaper and more efficient for the service provider to provide the user with a new authentication device 16 when the user's current authentication device 16 no longer functions correctly instead of repairing the user's non-functioning authentication device 16. To further keep the cost of authentication device 16 low, authentication device 16 may be manufactured so that it is not programmable after the PPPoE has been embedded within processing resource 22. Further adding to the low costs, existing users who received a CPE 14 before authentication device 16 was available need only receive authentication device 16 and not a new CPE 14 because authentication device 16 is compatible with the existing CPEs.

Instead of installing the PPPoE software in computing device 12, the PPPoE is embedded within processing resource 22 so that computing device 12 is no longer involved in the authentication process. Authentication device 16 receives a communication from computing device 12 when the user is attempting to access network 18. Authentication device 16 utilizes the PPPoE embodied in processing resource 22 to authenticate the user. Once authentication device 16 has authenticated the user, the user connects to network 18 and authentication device 16 becomes transparent to computing device 12 having no routing or bridging functionality. Authentication device 16 does not have to access computing device 12. Authentication device 16 receives a communication from computing device 12, authenticates the user, and then allows for a straight pass between computing device 12 and CPE 14.

Because no PPPoE software is installed in computing device 12, a user will not experience any of the incompatibility problems caused by the installed PPPoE software creating a virtual NIC within computing device 12. Therefore, the user does not need to be supplied with any PPPoE software and no PPPoE software is installed on computing device 12. Not installing the PPPoE software on computing device 12 saves the service provider additional money because the service provider no longer has to pay any license fees for the PPPoE software. Under the previous systems where the PPPoE software was installed on computing device 12, each time the service provider increased its subscriber base, it had to pay additional license fees for the PPPoE software. But since PPPoE is a publicly available standard, the service provider does not have to pay any license fees when PPPoE is embedded within processing resource 22.

Authentication device 16 further includes indicator 38. Indicator 38 indicates to the user an operating status for authentication device 16 where the operating status is whether authentication device 16 is functioning correctly. For instance, indicator 38 may be a light such as a light emitting diode (“LED”) that lights when authentication device 16 is functioning correctly and does not light when authentication device 16 is not functioning correctly. In addition to or in place of indicator 38, authentication device 16 may provide an error prompt on monitor 20 of computing device 12 to alert the user that authentication device 16 is not functioning correctly. The error prompt notifies the user to contact the service provider for a new authentication device 16.

Indicator 38 combined with the low cost of authentication device 16 reduces the time and money required to provide service to users experiencing authentication errors. Under previous systems, when the user experiences an error, the user calls a service provider CSR. Over the telephone, the CSR attempts to take the user through a process to determine the cause of the error. If that is unsuccessful, a service provider technician must visit the user site to diagnose and fix the problem. But with indicator 38, a CSR can diagnose and solve the authentication error over the telephone quickly and easily without having to send a service provider technician to the user site. For example, the CSR can ask the user if indicator 38 is lit which is something that can be easily checked by a user having no computer knowledge. If indicator 38 is lit, then the CSR knows there is not an authentication error and can go about determining the source of the problem by asking the user additional questions. But if indicator 38 is not lit, then the CSR immediately knows there is an error with authentication device 16. Because of the low cost and “throw-away” nature of authentication device 16, the CSR can mail to the user a new authentication device 16 which solves the problem or the user can travel to the service provider office and pick up a new authentication device 16 if the user does not want to wait for the mail. And because of the low cost of authentication device 16 and the fact that the service provider avoids the cost of sending a technician to the user site, the service provider saves time and money and the user does not need to worry about returning the nonfunctioning authentication device 16 to the service provider and can therefore just throw it away and wait for the new authentication device 16 in the mail.

In addition, authentication device 16 may include limited functionality that allows the service provider to remotely access authentication device 16 through network 18 and provide one or more upgrades to the firmware of authentication device 16 or alter the configuration of authentication device 16. This allows authentication device 16 to be upgraded without the users having to take the time to schedule an appointment for a service provider technician to come to the user's site and perform the upgrade and it allows the service provider to upgrade all authentication devices 16 in a short amount of time.

Although the present invention has been described in detail, it should be understood that various changes, substitutions and alterations can be made hereto without departing from the spirit and scope of the invention as defined by the appended claims.

What is claimed is:

1. A system for authenticating one or more DSL users, the system comprising:
a computing device;
a modem interfaced with the computing device;
a processing resource interfaced with the computing device and the modem and remotely located from the computing device and the modem, the processing resource including Point-to-Point Protocol over Ethernet and operable to authenticate a user of the computing device and the modem;
one or more Ethernet input ports associated with the processing resource;
one or more Ethernet output ports associated with the processing resource;
a housing associated with the processing resource, the housing operable to enclose the processing resource; and
an indicator associated with the processing resource, the indicator operable to indicate to the user an operating status of the processing resource.

2. A system for authenticating one or more users, the method comprising:
a computing device;
a customer premise equipment interfaced with the computing device; and
an authentication device remotely located from the computing device and interfaced with the computing device and the customer premise equipment, the authentication device including Point-to-Point Protocol over Ethernet and operable to authenticate a user of the computing device and the customer premise equipment.

3. The system of claim 2 wherein the authentication device includes one or more Ethernet input ports and one or more Ethernet output ports.

4. The system of claim 2 wherein the authentication device includes one or more processing resources.

5. The system of claim 4 wherein the authentication device further includes a housing operable to enclose the processing resource.

6. The system of claim 2 further comprising an indicator associated with the authentication device, the indicator operable to indicate to the user an operating status of the authentication device.

7. The system of claim 2 further comprising the authentication device disposed within the customer premise equipment.

8. The system of claim 2 further comprising the authentication device operable to provide one or more error prompts when the authentication device experiences an error.

9. The system of claim 2 further comprising the authentication device operable to utilize the IETF RFC 2516 standard.

10. The system of claim 2 wherein the Point-to-Point Protocol over Ethernet is embedded within a processing resource disposed within the authentication device.

11. The system of claim 2 further comprising one or more cables associated with the authentication device, the one or more cables operable to interface the authentication device with the computing device and the modem.

12. The system of claim 2 further comprising the authentication device operable to connect to a network and receive one or more upgrades from a remote location.

13. An authentication device comprising:
a processing resource including Point-to-Point Protocol over Ethernet and operable to authenticate a user of a computing device and a customer premise equipment;
one or more Ethernet ports associated with the processing resource; and
an indicator associated with the processing resource, the indicator operable to indicate to the user an operating status of the processing resource.

14. The authentication device of claim 13 further comprising a housing associated with the processing resource, the housing operable to enclose the processing resource.

15. The authentication device of claim 13 further comprising one or more cables associated with the processing resource, the one or more cables operable to interface the processing resource with the computing device and the customer premise equipment.

16. The authentication device of claim 13 further comprising the processing resource disposed between the computing device and the customer premise equipment.

17. The authentication device of claim 13 further comprising the processing resource operable to provide one or more error prompts when the processing resource experiences an error.

18. The authentication device of claim 13 wherein the Point-to-Point Protocol over Ethernet is embedded within the processing resource.

19. The authentication device of claim 13 wherein the indicator comprises a light emitting diode.

20. The authentication device of claim 13 further comprising the processing resource operable to connect to a network and receive one or more upgrades.
